(19) United States
(12) Patent Application Publication
(10) Pub. No.: US 2005/0024871 A1
(43) Pub. Date: Feb. 3, 2005

(54) Decorative tree lamp

(76) Inventor: Jeng-Shyong Wu, Hsin-Chu City (TW)

Correspondence Address: MCGLEW & TUTTLE, PC, 1 SCARBOROUGH STATION PLAZA, SCARBOROUGH, NY, 10510-0827, US

(21) Appl. No.: 10/677,914

(22) Filed: Oct. 2, 2003

(30) Foreign Application Priority Data
Mar. 11, 2003 (CN) 03238503.X

(51) Int. Cl. F21S 13/14

(52) U.S. Cl. 362/252; 362/2; 362/564; 362/567; 362/568; 362/249; 362/805; 362/806; 362/808; 362/812

(57) ABSTRACT

The present invention relates to a kind of decorative tree lamp, including a long trunk to be composed of many short pipes, the height of tree lamp can be adjustable by the number of the short pipe, said short pipe on the long trunk providing with one or more connecting rings to connect with many branches; base frame is to use a supporting surface to erect the base frame and has a center axle to support long trunk to stand up right straight; multiple branches connect one end with the connecting ring on the short pipe, to use the connecting ring as the base point, the other end of the branch is the center of the trunk to be able to stretch out to form a tree shape and also can be folded up to reduce the volume; single or multiple sets of light strings, composed of many lamp bulbs, lamp holders, electrical conductors and receptacles, to use the fixed device to fix them on the branches to establish tree light strings.

### BACKGROUND OF THE INVENTION

A conventional lamp light string set in a Christmas light string is consisting of a lamp bulb, lamp base, lamp holder, multiple electrical conductors, receptacles or flasher control, wherein the electrical conductors can be single or double or more than two wound into an electrical circuit. The distributed conductors can be formed in one, two or more than two electrical conductors, such as the FIG. 4 of U.S. Pat. No. 4,241,387 and the FIGS. 1 and 2 of the prior art in this case. In general, it is to use said electrical conductors to be wound in the trees. Such is troublesome and monotonous. Further, such kind of work is used several years. The present invention is an improvement in the defects of the conventional products. It is to use artificial trunks and branches of tree to make the decorative light strings along with the electrical connectors wound on the trees, so that the decorative light strings and branches of trees are to form a shape so as to obtain a decorative effect.

### SUMMARY OF THE INVENTION

The present invention is to make a conventional Christmas light strings be easy to transport and to make an improvement in the defects of the conventional products. The present invention relates to use a kind of decorative tree lamp, including a long trunk to be composed of many short pipes, the height of tree lamp can be adjustable by the number of the short pipe, said short pipe on the long trunk providing with one or more connecting rings to connect with many branches; base frame is to use a supporting surface to erect the base frame and has a center axle to support long trunk to stand up right straight; multiple branches connect one end with the connecting ring on the short pipe, to use the connecting ring as the base point, the other end of the branch is the center of the trunk to be able to stretch out to form a tree shape and also can be folded up to reduce the volume; single or multiple sets of light strings, composed of many lamp bulbs, lamp holders, electrical conductors and receptacles, to use the fixed device to fix them on the branches to establish tree light strings.

The present invention relates to the decorative tree lamp and its characteristic is the branch being a single pillar as well as extending to sub-branches.

The present invention relates to the decorative tree lamp and its characteristic is the branch being multiple pillars twisting and extending to sub-branches.

The present invention relates to the decorative tree lamp and its characteristic is light string connected single electrical conductor with lamp holder and lamp bulb.

The present invention relates to the decorative tree lamp and its characteristic is the light string to use single electrical conductor twisted and connected with non-electrical connector, and the decorative golden scallions attach to the non-electrical connector.

The present invention relates to the decorative tree lamp and its characteristic is the light string to use multiple electrical conductors connected with lamp holder and lamp bulb as well as twisting and winding each other.

The present invention relates to the decorative tree lamp and its characteristic is to use the fixed device of C-clip to clip and fix the electrical conductor and branches.

The present invention relates to the decorative tree lamp and its characteristic is to use the fixed device to twist and fix the electrical conductor on the branches.

The present invention relates to the decorative tree lamp and its characteristic is to use the fixed device by using non-electrical connector to twist and wind the electrical conductor and to fix on the branches, also the decorative golden scallions can attach to the non-electrical connector.

The present invention relates to the decorative tree lamp and its characteristic is to use the fixed device of a movable clip to fix and fasten the electrical conductor and branches tightly.

The present invention relates to the decorative tree lamp and its characteristic is to use movable clip having two concave arms with hollow trough toward inner. There is a slice between the arms, the end of one arm has a hole, and the end of the other arm has a hook flange, to use the slice as curve line to fold up toward inner, to clip the electrical conductor and branch to be located at hollow trough. The upside hook flange goes through to the hole on the other end, and the flange fastens tightly on the hole edge prevented it from loosing.

The present invention relates to the decorative tree lamp and its characteristic is the fixed device used to fix single or multiple electrical conductors and single or multiple pillars together so as not to loose.

The present invention relates to the decorative tree lamp and its characteristic is the lamp holder of the light string being cylinder, said lamp holder is connected with electrical conductor. After the fixed device is to fix with electrical conductor, the decorative tree lamp can be suspended freely in the air as wish.

The present invention relates to the decorative tree lamp and its characteristic is the fixed device to use the fixed cover connecting the branch tail, and the cover hole fixes tightly on the lamp holder.

The present invention relates to the decorative tree lamp and its characteristic is to use fixed cover with one end having a hole, the branch tail goes through the hole to connect and fix tightly. The other end has a cover hole, and its edge has a gap, when it fits into the lamp holder, the elasticity is to fit the lamp holder tightly so as not to fall off easily.

The present invention relates to the decorative tree lamp and its characteristic is the surrounding edge of the circumference of the lamp holder having a hook. It is able to individually or simultaneously hook the electrical conductor, non-electrical connector or branch, to let lamp holder and lamp bulb be fixed on the position or direction.

The present invention relates to the decorative tree lamp and its characteristic is to use single circuit loop or many sets of single circuit loop of light string to connect the power in receptacle individually.

The present invention relates to the decorative tree lamp and its characteristic is to use single circuit loop or many sets of single circuit loop of light string to connect the power in receptacle simultaneously or individually.

The present invention relates to the decorative tree lamp and its characteristic is the light string having attached protection device, transformer or functional control device to increase the decoration functionality.

The present invention relates to the decorative tree lamp and its characteristic is the branch being able to bending metal threads.

The present invention relates to decorative tree lamp. It is another kind of decorative lamp tree including a long trunk to be composed of many short pipes, the height of tree lamp can be adjustable by the number of the short pipe, the short pipe has one or many connecting rings to connect with branches; base frame has many supporting frames and the center of the frames used as axle to support long trunk to stand up right straight; multiple branches and base part of the branch to form a round shape and there is a hole on the central part between two vanes, to use the pin from one end of the vane going through its hole, then going through the hole of the base part of branch to another hole of the vane. The pin is fixed and the pin is used as an axle to make branches stretch out to form a tree shape and also fold up to reduce the volume; single or multiple sets of light strings composed of many lamp bulbs, lamp holders, electrical conductors and receptacles, to use the fixed device to fix them on the branches to establish tree light strings.

### BRIEF DESCRIPTION OF THE DRAWINGS

The detailed descriptions are done accompanying the drawings and preferred embodiments of the present invention:

FIG. 1 is a perspective view of the decorative tree lamp of the prior art.

FIG. 2 is a perspective view with 3-dimention showing the practical structure of the decorative tree lamp of the present invention;

FIG. 3 is a perspective view showing the structure of long trunk and light string of the decorative tree lamp of the present invention.

FIG. 3A is a perspective view showing the structure of fixed cover on the single or multiple branches of the decorative tree lamp of the present invention.

FIG. 4 is a perspective view of single or multiple branches of a further embodiment of the decorative tree lamp of the present invention.

FIG. 5 is a perspective view showing the connection style of fixed device of the decorative tree lamp of the present invention.

FIG. 5A is a perspective view of fixed device of the decorative tree lamp of the present invention.

FIG. 5B is a perspective view with side view of fixed device of the decorative tree lamp of the present invention.

FIG. 6 is a perspective view showing the use of branches of the decorative tree lamp of the present invention.

FIG. 7 is a perspective view showing the use of branches and other decorations of the decorative tree lamp of the present invention.

FIG. 8 is a perspective view of the preferred and further embodiment showing the use of branches and other decorations of the decorative tree lamp of the present invention.

FIG. 9 is a perspective view showing the use of lamp holder and its twisted and wound wires of the decorative tree lamp of the present invention.

### DETAILED DESCRIPTION OF THE PREFERRED EMBODIMENTS

For the convenience of the description, the same composing part is to show the same number in the drawings.

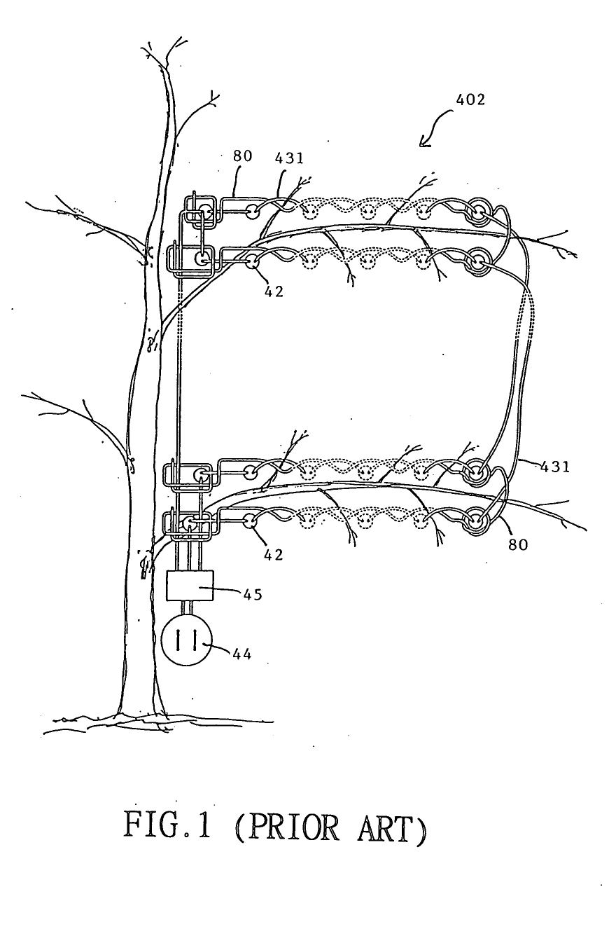

Now, referring to FIG. 1, it is a perspective view of the conventional light string and the electrical conductor is used to connect lamp holder 42 and lamp bulb 41, also the structure is formed by using serial or serial-parallel. The single electrical conductor 431 or many electrical conductors are used to form single loop or multiple loop 402 and the loop attached with non-electrical connector 80. The receptacle 44 connects with light string and power supply, between receptacle 44 and lamp holder 42, a protected device, transformer or functional control device 45 are attached to, lamp holder attached with hook trough is used to hang on the electrical conductor 431 and non-electrical connector 80, then to hang on the tree to establish decorative tree lamp.

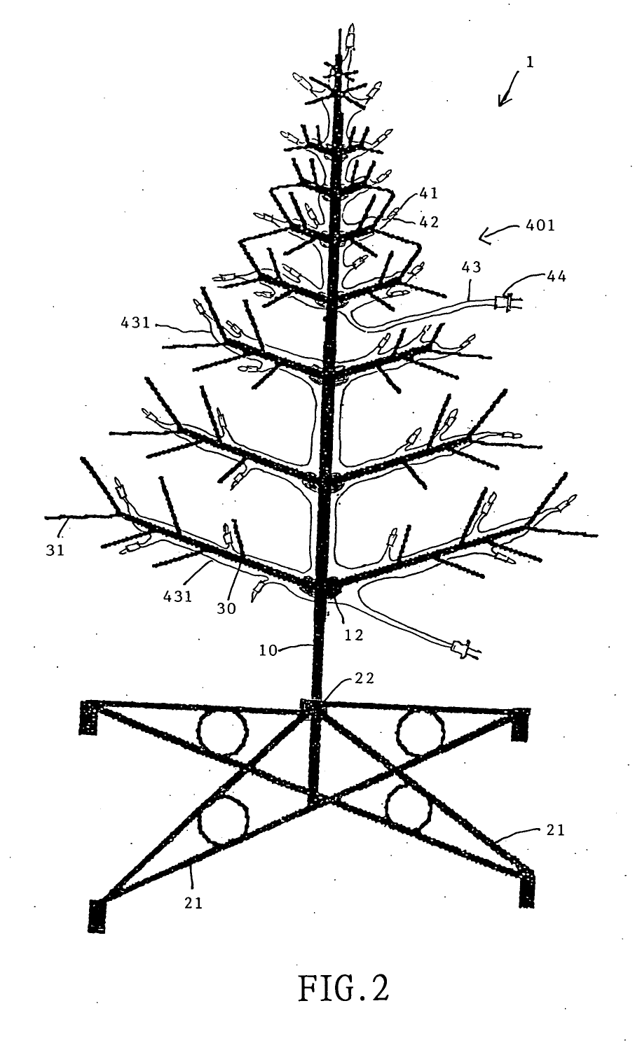

FIG. 2 is a perspective view with 3-dimention showing the practical structure of the decorative tree lamp of the present invention. It is showing the structure of the decorative tree lamp, which includes long trunk 10 connected with many nodes of short pipe 11, the number of short pipes decides the length of the tree lamp, the short pipe 11 has one or many connecting rings 12 connected with branches 30; base frame 20 has many supporting frames 21, the center of the frames is an axis 22 to support long trunk 10 to stand up vertically; one end of multiple branches 30 connects with the connecting ring 12 on the short pipe 11, by using connecting ring 12 as the base point. The other end of branches 30 is to use long trunk 10 as axis to extend to the designed tree shape, also can be folded up to reduce the volume; single or multiple sets of light string 40 is also consisting of many lamp bulb 41, lamp holder 42, electrical conductor 43 and receptacle 44. The fixed device 60 is used to fix said light string on the branches to establish the tree lamp.

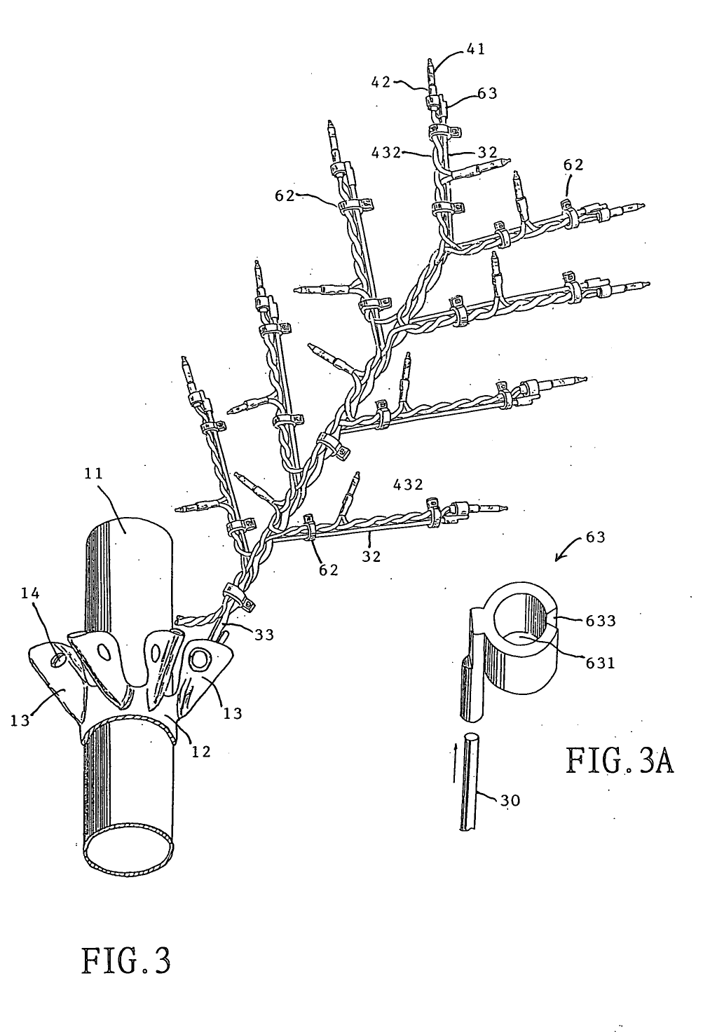

FIG. 3 is a perspective view showing the structure of long trunk and light string of the decorative tree lamp of the present invention. Its long trunk 10 is connected by many node of short pipes 11, connecting ring 12 attached on the short pipe 11, and vane 13 having hole 14 equipped on connecting ring 12, branches having many pillars 33 are used and their base part to form a round shape with the center having a hole, said branch is put on the center between the vane 13 of connecting ring 12, one end of pin goes through the hole from the hole on its vane, then goes through the hole on the branch and fix it, and this pin is used as an axis. Single or many sets of light string are used on the branches, and said light string is consisting of many lamp bulb 42, lamp holder 42, electrical conductor 432 and receptacle. The fixed device is used to fix it on the branches. The fixed device 60 can use moveable clip 62 to fix the light string 40 on the tree lamp to establish the decorative tree lamp. Further, the branches 30 can also use a single pillar 32.

FIG. 3A is a perspective view showing the structure of fixed cover in the single or multiple branches of the decorative tree lamp of the present invention. Said fixed cover 63 sticks into branch 30 to fix the fixed cover 63 on the branch 30. The fixed cover 63 has cover hole 631 and the gap 633. The lamp holder 42 via the gap 633 can put into the cover hole 631 so as to fix the lamp holder 42.

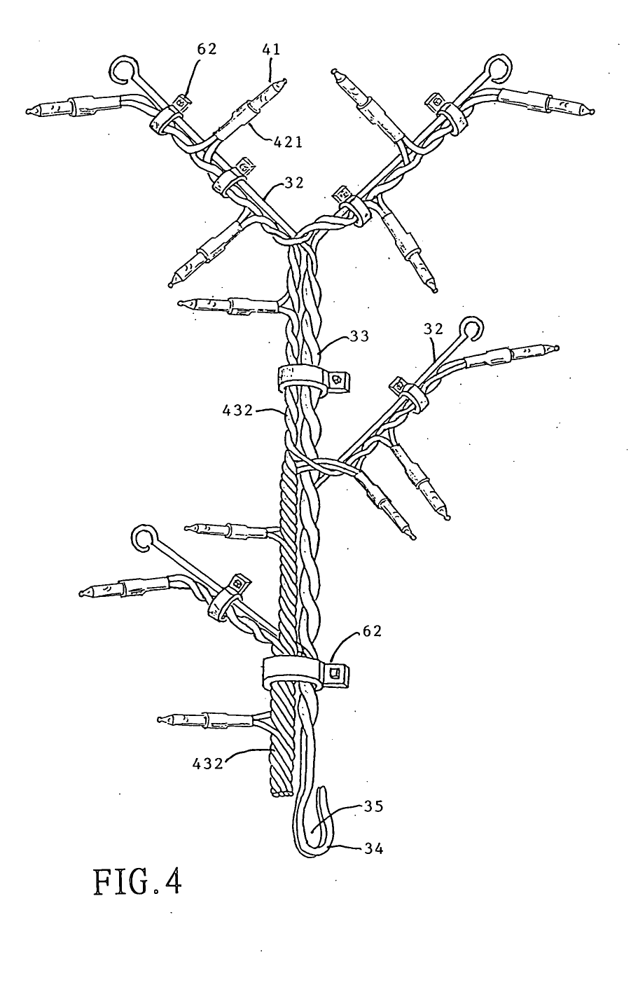

FIG. 4 is a perspective view of single or multiple branches of a further embodiment of the decorative tree lamp of the present invention. The base part 34 of many pillars 33 twists as a round shape and the center is the hole 35 to be put between dual vanes of the connecting ring. One end of pin goes through the hole 35 on the vane, and goes through the hole on the branch 30 and the pin is fixed. The pin is used as an axis. The other end of the branch 30 is to use long trunk 10 as an axis to extend to the designed tree shape and also be able to fold up so as to reduce the volume.

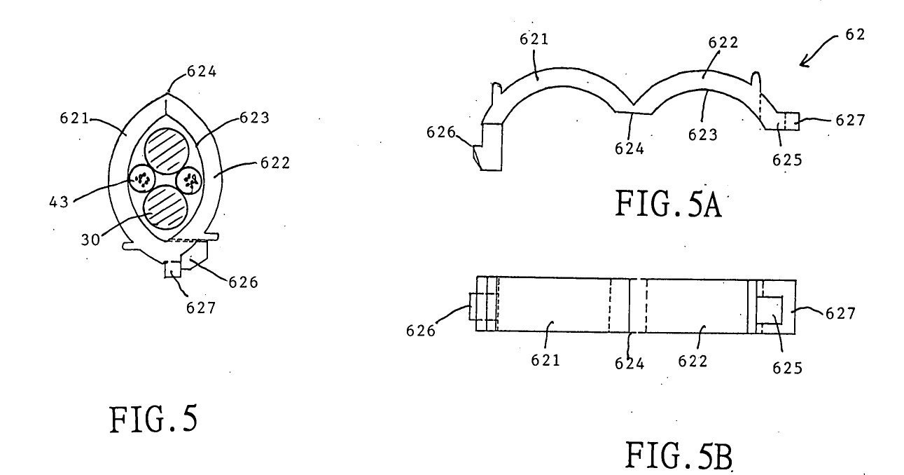

FIG. 5 is a perspective view showing the connection style of fixed device of the decorative tree lamp of the present invention. The movable clip 62 is used to fasten and fix tightly the electrical conductor 43 and branches 30. The movable clip 62 has toward inner of concave trough with two arms 621, 622. A slice 624 is provided between two arms. The end of one arm has hole 625, and the other end has upside hook flange 626. The slice is used as curve line, and two arms are folded up toward inner. The electrical conductor and branch are clipped at the concave trough. The upside hook flange 626 goes through to the other end of the hole, and the flange is fastened tightly on the hole rim 627 so as not to loose.

FIG. 5A is a perspective view of fixed device of the decorative tree lamp of the present invention. The movable clip 62 of the fixed device is the drawing before it is fixed and connected. FIG. 5B is its side view.

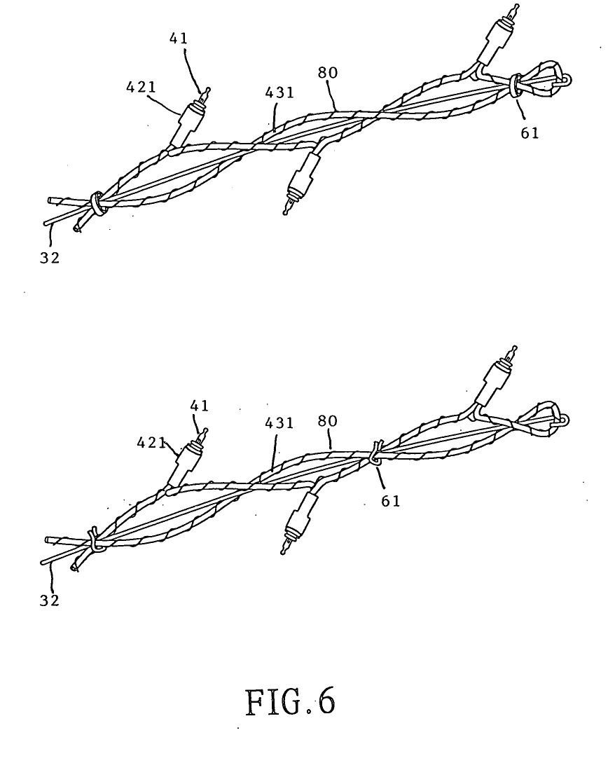

FIG. 6 is a perspective view showing the use of branches of the decorative tree lamp of the present invention. The light string is composed of single electrical conductor 431 to connect with lamp holder 421 and lamp bulb 41. The single electrical conductor 431 and non-electrical connector 80 are twisted and wound to form such structure. The L-clip 61 is used to clip and fix the electrical conductor and branches tightly.

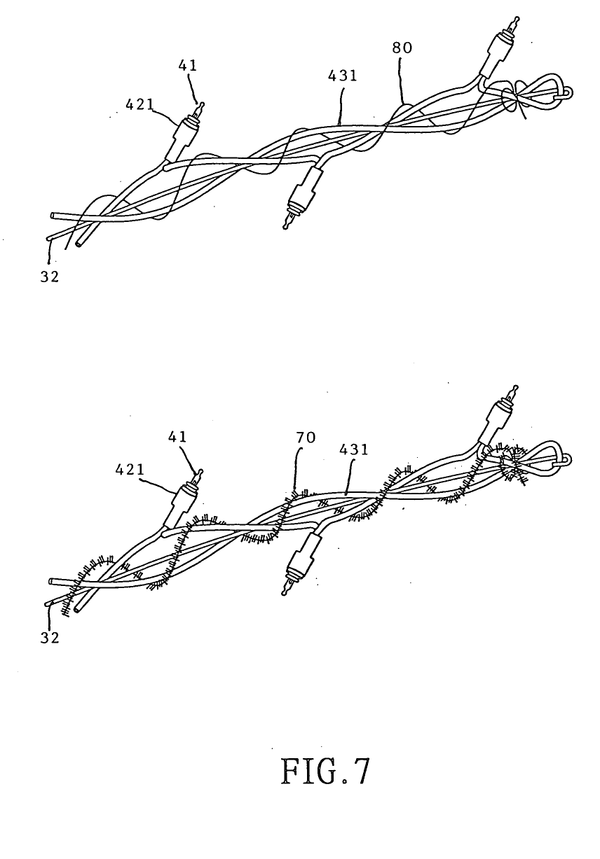

FIG. 7 is a perspective view showing the use of branches of the decorative tree lamp of the present invention. The structure is identical with that of in FIG. 6, but the decorative golden scallions 70 attached to the non-electrical connector to increase decoration effect.

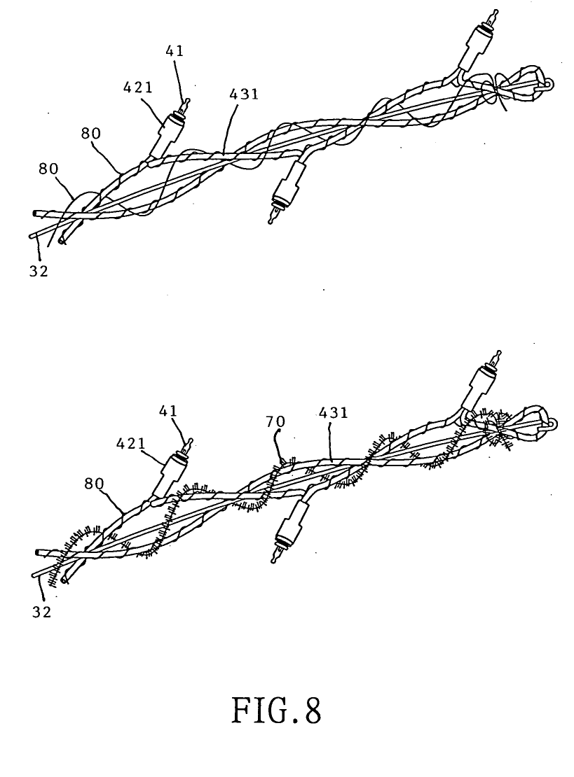

FIG. 8 is a perspective view of the preferred and further embodiment showing the use of branches and other decorations of the decorative tree lamp of the present invention. Its structure is identical with those of in FIG. 6 and FIG. 7.

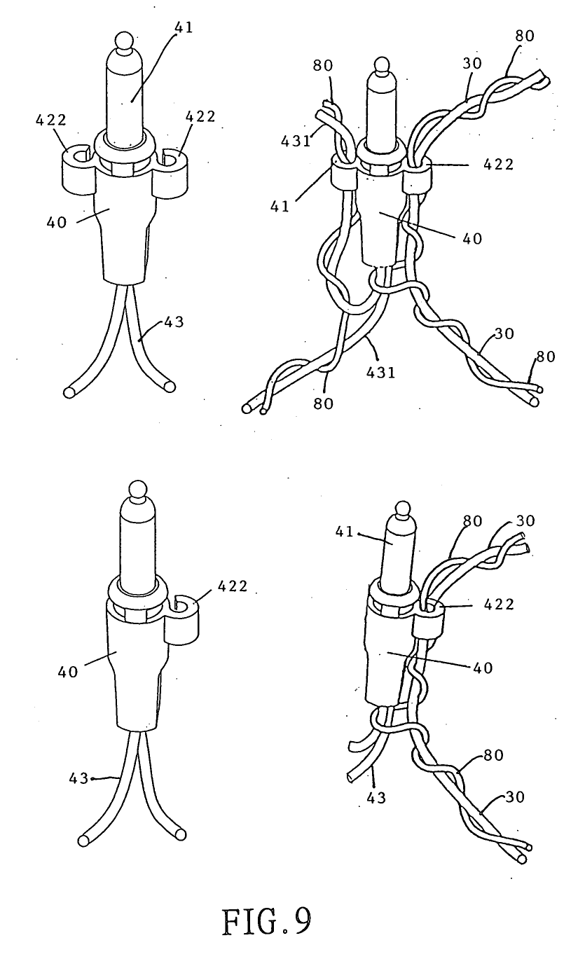

FIG. 9 is a perspective view showing the use of lamp holder and its twisted and wound wires of the decorative tree lamp of the present invention. Its twisted and wound wires style are the surrounding edge of the circumference of the lamp holder 40 having hook trough 422 being able to hook the electrical conductor 43, non-electrical connector 80 or branches 30 individually or simultaneously to make lamp holder 40 and lamp bulb 41 be fixed on the right position or direction.

From the foregoing it will be appreciated that although specific embodiments of the invention have been described herein for purposed of illustration, various modifications and improvements thereon will become readily apparent to those skilled in the art. Accordingly, the appended claims are to be construed broadly and in a manner consistent with the spirit and scope of the invention described herein.

Symbol Lists

| | |
|---|---|
| 1 | decorative tree light string |
| 10 | long trunk |
| 11 | short pipe |
| 12 | connecting ring |
| 13 | vane |
| 14 | hole on vane |
| 20 | base frame |
| 21 | supporting frame |
| 22 | axis |
| 30 | branches |
| 31 | sub-branches |
| 32 | single pillar |
| 33 | many pillars |
| 34 | base part |
| 35 | hole |
| 40 | light string |
| 401 | single loop |
| 402 | multiple loop |
| 41 | lamp bulb |
| 42 | lamp holder |
| 421 | round pillar shape |
| 422 | hook trough on lamp holder |
| 43 | electrical conductor |
| 431 | single |
| 432 | multiple |
| 44 | receptacle |
| 45 | functional control device |
| 50 | pin |
| 60 | fixed device |
| 61 | C-clip |
| 62 | movable clip |
| 621 | arms |
| 622 | arms |
| 623 | concave trough |
| 624 | vane |
| 625 | hole |
| 626 | upside hook flange |
| 627 | hole rim |
| 63 | fixed cover |
| 631 | cover hole |
| 633 | gap |
| 70 | decorating golden scallions |
| 80 | non-electrical connector |

1. A decorative tree lamp, including:
long trunk: composed of many short pipes, the height of tree lamp being adjustable by the number of the short pipe, said short pipe on the long trunk providing with one or more connecting rings to connect with many branches;
base frame; using a supporting surface to erect the base frame and having a center axle to support long trunk to stand up right straight;
multiple branches: connected one end with the connecting ring on the short pipe, to use the connecting ring as the base point, the other end of the branch being the center of the trunk to be able to stretch out to form a tree shape and also able to be folded up to reduce the volume;
single or multiple sets of light strings: composed of many lamp bulbs, lamp holders, electrical conductors and receptacles, to use the fixed device to fix them on the branches to establish tree light strings.

2. A decorative tree lamp as claimed in claim 1, wherein the branch being a single pillar as well as extending to sub-branches.

3. A decorative tree lamp as claimed in claim 1, wherein the branch being multiple pillars twisting and extending to sub-branches.

4. A decorative tree lamp as claimed in claim 1, wherein the light string connected single electrical conductor with lamp holder and lamp bulb.

5. A decorative tree lamp as claimed in claim 4, wherein the light string using non-electrical connector to twist and wind the electrical conductor and to fix on the branches, also the decorative golden scallions being attached to the non-electrical connector.

6. A decorative tree lamp as claimed in claim 1, wherein the light string to use multiple electrical conductors connected with lamp holder and lamp bulb as well as twisting and winding each other.

7. A decorative tree lamp as claimed in claim 1, wherein the fixed device of C-clip being used to clip and fix the electrical conductor and branches.

8. A decorative tree lamp as claimed in claim 1, wherein the fixed device being twisted and fixed by the electrical conductor on the branches.

9. A decorative tree lamp as claimed in claim 1, wherein the fixed device by using non-electrical connector to twist and wind the electrical conductor and to fix on the branches, also the decorative golden scallions being attached to the non-electrical connector.

10. A decorative tree lamp as claimed in claim 1, wherein the fixed device of a movable clip being used to fix and fasten the electrical conductor and branches tightly.

11. A decorative tree lamp as claimed in claim 10, wherein the movable clip having two concave arms with hollow trough toward inner, a slice between the arms, the end of one arm having a hole, and the end of the other arm having a hook flange, to use the slice as curve line to fold up toward inner, to clip the electrical conductor and branch to be located at hollow trough, the upside hook flange being to go through to the hole on the other end, and the flange to be fastened tightly on the hole rim prevented it from loosing.

12. A decorative tree lamp as claimed in claim 1, wherein the fixed device used to fix single or multiple electrical conductors and single or multiple pillars together so as not to loose.

13. A decorative tree lamp as claimed in claim 1, wherein the lamp holder of the light string being cylinder, said lamp holder being connected with electrical conductor, after the fixed device being fixed with electrical conductor, the decorative tree lamp to be suspended freely in the air as wish.

14. A decorative tree lamp as claimed in claim 1, wherein the fixed device to use the fixed cover connecting the branch tail, and the cover hole fixed tightly on the lamp holder.

15. A decorative tree lamp as claimed in claim 14, wherein the fixed cover with one end having a hole, the branch tail being to go through the hole to connect and fix tightly, the other end having a cover hole, and its edge having a gap, when it fitted into the lamp holder, the elasticity being to fit the lamp holder tightly so as not to fall off easily.

16. A decorative tree lamp as claimed in claim 1, wherein the surrounding edge of the circumference of the lamp holder having a hook, able to individually or simultaneously hook the electrical conductor, non-electrical connector or branch, to let lamp holder and lamp bulb be fixed on the position or direction.

17. A decorative tree lamp as claimed in claim 1, wherein the single circuit loop or many sets of single circuit loop of light string being used to connect the power in receptacle simultaneously or individually.

18. A decorative tree lamp as claimed in claim 1, wherein the single circuit loop or many sets of single circuit loop of light string being used to connect the power in receptacle simultaneously or individually.

19. A decorative tree lamp as claimed in claim 1, wherein the light string having attached protection device, transformer or functional control device to increase the decoration functionality.

20. A decorative tree lamp as claimed in claim 1, wherein the branch being metal threads able to be bent.

21. A decorative lamp tree including:
long trunk: composed of many short pipes, the height of tree lamp can be adjustable by the number of the short pipe, the short pipe has one or many connecting rings to connect with branches;
base frame: having many supporting frames and the center of the frames used as axle to support long trunk to stand up right straight;
multiple branches: the base part of the branch to form a round shape and a hole on the central part between two vanes, to use the pin from one end of the vane going through its hole, then going through the hole of the base part of branch to another hole of the vane, the pin being fixed and the pin being used as an axle to make branches stretch out to form a tree shape and also fold up to reduce the volume;
single or multiple sets of light strings: composed of many lamp bulbs, lamp holders, electrical conductors and receptacles, to use the fixed device to fix them on the branches to establish tree light strings.
